(19) United States
(12) Patent Application Publication
(10) Pub. No.: US 2026/0112711 A1
(43) Pub. Date: Apr. 23, 2026

(54) BATTERY STRUCTURE, COMMUNICATION ASSEMBLY, AND MANUFACTURING METHOD OF BATTERY STRUCTURE

(71) Applicant: Smart Approach CO.,LTD., Zhubei City (TW)

(72) Inventors: Hsin-Lung LIN, Zhubei City (TW); You Long LAI, Zhubei City (TW); Wen-Chung TIEN, Zhubei City (TW)

(21) Appl. No.: 18/988,475

(22) Filed: Dec. 19, 2024

(30) Foreign Application Priority Data
Oct. 21, 2024 (TW) 113139953

(51) Int. Cl. H01M 10/42; H01M 50/474; H01M 50/477; H01M 50/483; H01M 50/548

(52) U.S. Cl. CPC H01M 10/425; H01M 50/474; H01M 50/477; H01M 50/483; H01M 50/548; H01M 2010/4278

(57) ABSTRACT

A battery structure includes a cell body, a communication assembly, and a cover layer. The cell body has a positive terminal and a negative terminal that are opposite to each other. The communication assembly includes a spacing ring and a radio frequency tag. The spacing ring is disposed on a side of the cell body where the positive terminal is located. The radio frequency tag includes a signal-emitting element and a chip. The signal-emitting element is disposed on a side of the spacing ring away from the cell body. The chip is disposed on a side of the signal-emitting element close to the spacing ring. The spacing ring or the cell body accommodates the chip. The cover layer covers the cell body and the communication assembly and exposes the positive terminal, at least part of the negative terminal and at least part of the signal-emitting element.

### CROSS-REFERENCE TO RELATED APPLICATIONS

This non-provisional application claims priority under 35 U.S.C. § 119 (a) on Patent Application No(s). 113139953 filed in Taiwan on Oct. 21, 2024, the entire contents of which are hereby incorporated by reference.

### TECHNICAL FIELD

The present disclosure relates to a battery structure, a communication assembly and a manufacturing method of a battery structure, more particularly to a battery structure having a communication assembly and a manufacturing method of the same.

### BACKGROUND

Batteries are widely used across various fields. To provide sufficient information about a battery, text or pattern are often printed or engraved on a battery. Recently, a two-dimensional code has also been used as a pattern to offer more detailed information through scanning.

However, the small size of some batteries can make the text or pattern difficult to be read. Additionally, environmental factors during battery usage can cause wear, dirt or melting the outer layer of the battery, rendering the text or pattern unreadable. Furthermore, it is challenging to directly store usage history record on the battery itself.

### SUMMARY

The present disclosure provides a battery structure, a communication assembly and a manufacturing method of a battery structure that enables easy reading and storage of related information of a battery.

According to one aspect of the present disclosure, a battery structure includes a cell body, a communication assembly and a cover layer. The cell body has a positive terminal and a negative terminal that are opposite to each other. The communication assembly includes a spacing ring and a radio frequency tag. The spacing ring is disposed on a side of the cell body where the positive terminal is located. The radio frequency tag includes a signal-emitting element and at least one chip. The signal-emitting element is in a ring shape and disposed on a side of the spacing ring away from the cell body. The at least one chip is disposed on a side of the signal-emitting element close to the spacing ring. The spacing ring has at least one accommodation space or the cell body has at least one accommodation space on the side thereof where the positive terminal is located. The at least one chip is located in the at least one accommodation space. The cover layer covers the cell body and the communication assembly and exposes the positive terminal, at least part of the negative terminal, and at least part of the signal-emitting element.

According to another aspect of the present disclosure, a communication assembly configured to be disposed on a cell body includes a spacing ring and a radio frequency tag. The radio frequency tag includes a signal-emitting element and at least one chip. The signal-emitting element is in a ring shape and disposed on a side of the spacing ring. The at least one chip is disposed on a side of the signal-emitting element close to the spacing ring. A side of the communication assembly where the signal-emitting element is not disposed is configured to be disposed on a side of the cell body where a positive terminal is located.

According to another aspect of the present disclosure, a manufacturing method of a battery structure includes the following steps: placing at least one chip on a signal-emitting element to jointly form a radio frequency tag; attaching the signal-emitting element to a spacing ring to jointly form a communication assembly; placing a side of the communication assembly where the signal-emitting element is not disposed on a side of a cell body where a positive terminal is located; and covering a cover layer on outer sides of the cell body and the communication assembly, wherein the cover layer exposes the positive terminal, at least part of a negative terminal of the cell body, and at least part of the signal-emitting element.

According to the battery structure, the communication assembly, and the manufacturing method of the battery structure discussed above, with the arrangement of the communication assembly, data stored in the chip of the battery structure can be successfully read, so that basic details such as manufacturing information and usage instructions of the battery structure can be provided to users, and users can also directly store usage history record of the battery structure in the chip. Moreover, the chip can be prevented from being affected during the manufacturing, such that the yield rate of the communication assembly can be improved.

### BRIEF DESCRIPTION OF THE DRAWINGS

The present disclosure will become more fully understood from the detailed description given hereinbelow and the accompanying drawings which are given by way of illustration only and thus are not intending to limit the present disclosure and wherein:

FIG. 1 is a side view of a battery structure according to one embodiment of the present disclosure;

FIG. 2 is an enlarged view of AA region of the battery structure in FIG. 1;

FIG. 3 is an exploded view of several components of the battery structure in FIG. 1;

FIG. 4 to FIG. 5 are flow charts showing a manufacturing method of the battery structure in FIG. 1;

FIG. 6 is a partial and enlarged view of a battery structure according to another embodiment of the present disclosure; and

FIG. 7 is an exploded view of several components of a battery structure according to further another embodiment of the present disclosure.

### DETAILED DESCRIPTION

Aspects and advantages of the invention will become apparent from the following detailed descriptions with the accompanying drawings. For purposes of explanation, one or more specific embodiments are given to provide a thorough understanding of the invention, and which are described in sufficient detail to enable one skilled in the art to practice the described embodiments. It should be understood that the following descriptions are not intended to limit the embodiments to one specific embodiment. On the contrary, it is intended to cover alternatives, modifications, and equivalents as can be included within the spirit and scope of the described embodiments as defined by the appended claims.

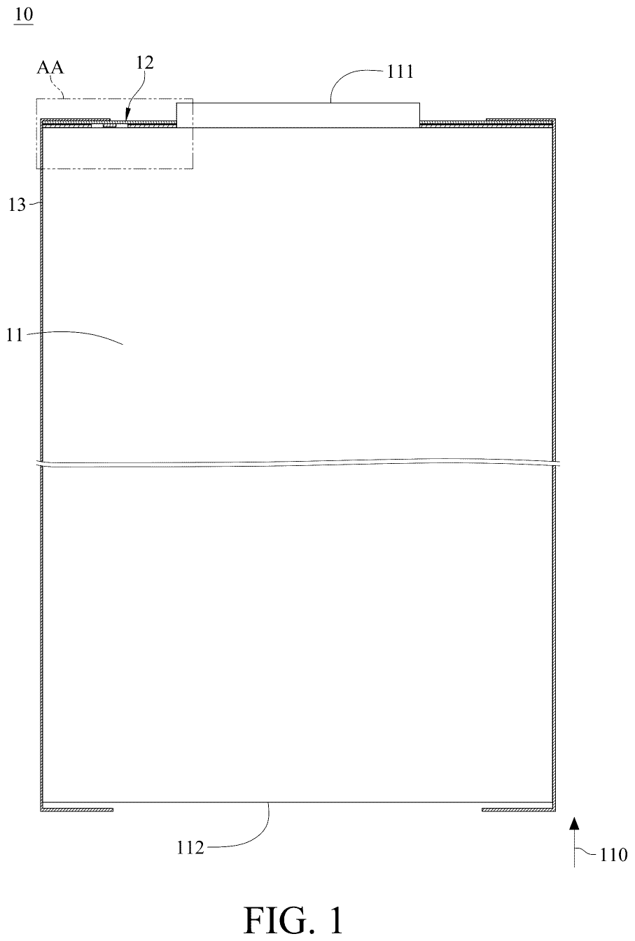

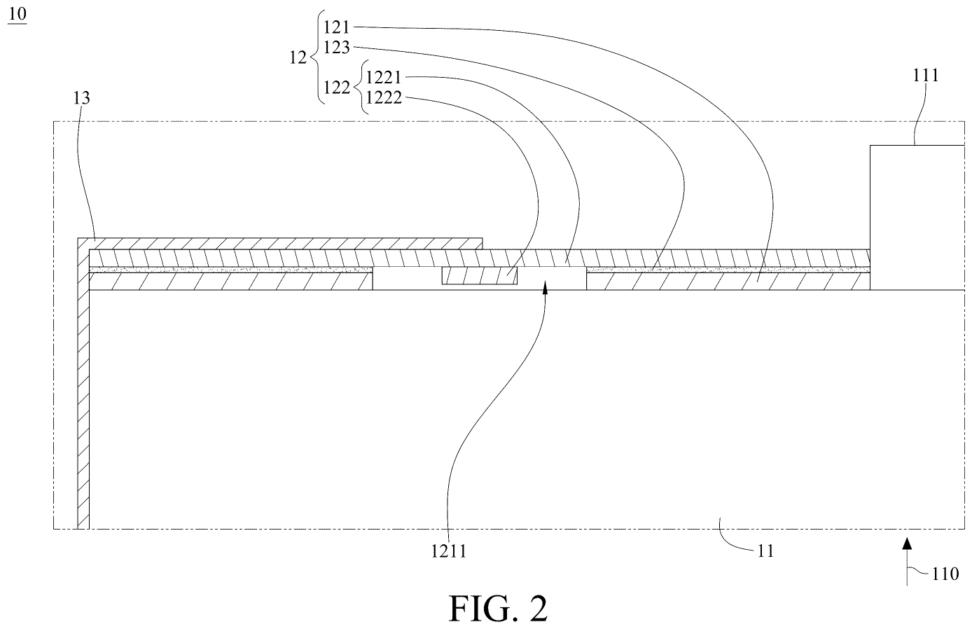

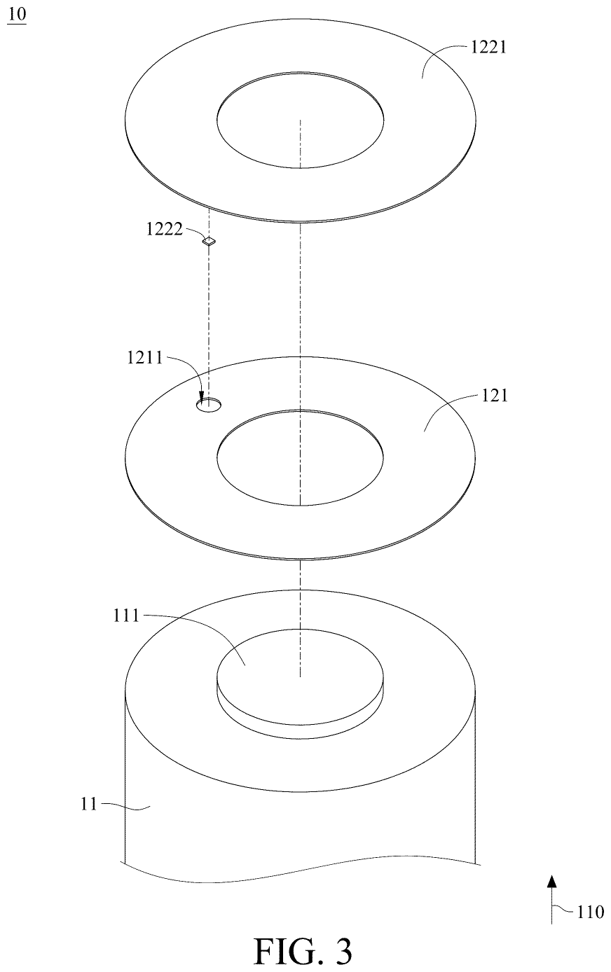

Please refer to FIG. 1 to FIG. 3, where FIG. 1 is a side view of a battery structure according to one embodiment of the present disclosure, FIG. 2 is an enlarged view of AA region of the battery structure in FIG. 1, and FIG. 3 is an exploded view of several components of the battery structure in FIG. 1.

A battery structure 10 provided in this embodiment includes a cell body 11, a communication assembly 12 and a cover layer 13.

The cell body 11 may have a positive terminal 111 and a negative terminal 112 that are opposite to each other along a longitudinal direction 110 of the cell body 11. The shape of the cell body 11 may be like a cylinder with a protrusion served as the positive terminal 111 in the longitudinal direction 110, but the present disclosure is not limited thereto.

The communication assembly 12 may include a spacing ring 121, a radio frequency tag 122 and an adhesive 123.

The spacing ring 121 may be made of, for example, ferrite or electromagnetic wave absorbing material. The spacing ring 121 is disposed on a side of the cell body 11 where the positive terminal 111 is located. The spacing ring 121 may surround the positive terminal 111. The spacing ring 121 may have an accommodation space 1211. The accommodation space 1211 may be a through hole passing through the spacing ring 121. Please be noted that the present disclosure is not limited to the quantity of the accommodation space 1211.

The radio frequency tag 122 may be, for example, a radio-frequency identification (RFID) tag. The radio frequency tag 122 may include a signal-emitting element 1221 and a chip 1222. Please be noted that the present disclosure is not limited to the quantity of the chip 1222.

The signal-emitting element 1221 is in a ring shape and can be attached on a side of the spacing ring 121 away from the cell body 11 through the adhesive 123. The signal-emitting element 1221 may surround the positive terminal 111. The signal-emitting element 1221 may include an antenna (not shown) to emit signals. In specific, the signal-emitting element 1221 may be an antenna, or the signal-emitting element 1221 may include a substrate (not shown) and an antenna (not shown) disposed on the substrate; the present disclosure is not limited thereto.

The chip 1222 may be disposed on a side of the signal-emitting element 1221 close to the spacing ring 121 and may be located in the accommodation space 1211. The thickness of the chip 1222 may be less than the sum of the thickness of the spacing ring 121 and the thickness of the adhesive 123, such that the chip 1222 can be spaced apart from the cell body 11 to prevent any possible short circuit between the chip 1222 and the cell body 11. The chip 1222 can store data, such as manufacturing information, usage instructions, and other basic details; even the usage history record of the cell body 11 can be stored into the chip 1222.

The cover layer 13 covers the cell body 11 and the communication assembly 12 and exposes the positive terminal 111, at least part of the negative terminal 112 and at least part of the signal-emitting element 1221. The cover layer 13 can secure the cell body 11 and the communication assembly 12 in position while preserving the readability of the chip 1222.

With the spacing ring 121 made of ferrite or electromagnetic wave absorbing material, the battery structure 10 can prevent the radio frequency tag 122 from being affected by the cell body 11 that is located adjacent to the radio frequency tag 122, even when the cell body 11 is provided in various types. This configuration ensures that data stored in the chip 1222 of the radio frequency tag 122 can be successfully read. Please refer to Table 1 in the following for relevant experimental results.

TABLE 1

| | | signal | | signal | signal | chip read |
|---|---|---|---|---|---|---|
| cell | | frequency | signal | bandwidth | strength | distance |
| type | spacing ring | (MHz) | Q-factor | (KHz) | (dBm) | (mm) |
| A | none | N/A | N/A | N/A | N/A | not |
| | | | | | | readable |
| | ferrite | 15.1~15.4 | 38~69 | 220~405 | 0.8~1 | 14.2~20.9 |
| | electromagnetic | 15.7~15.8 | 9~18 | 836~1760 | 0.6~0.7 | 0.8~13 |
| | wave absorbing | | | | | |
| | material | | | | | |
| B | none | N/A | N/A | N/A | N/A | not |
| | | | | | | readable |
| | ferrite | 15~15.8 | 50~68 | 225~310 | 0.8 | 20.3~22.9 |
| | electromagnetic | 15.4~15.9 | 8~14 | 1100~1990 | 0.5~0.6 | 5.3~15.8 |
| | wave absorbing | | | | | |
| | material | | | | | |
| C | none | N/A | N/A | N/A | N/A | not |
| | | | | | | readable |
| | ferrite | 13.7~13.8 | 4~5 | 3460~3470 | 0.4 | 13.9~15.8 |
| | electromagnetic | 13.8~14.2 | 5~6 | 2380~2810 | 0.4 | 13~21.5 |
| | wave absorbing | | | | | |
| | material | | | | | |

According to the battery structure 10 discussed above, with the arrangement of the communication assembly 12, data stored in the chip 1222 of the battery structure 10 can be successfully read, so that basic details such as manufacturing information and usage instructions of the battery structure 10 can be provided to users, and users can also directly store usage history record of the battery structure 10 in the chip 1222.

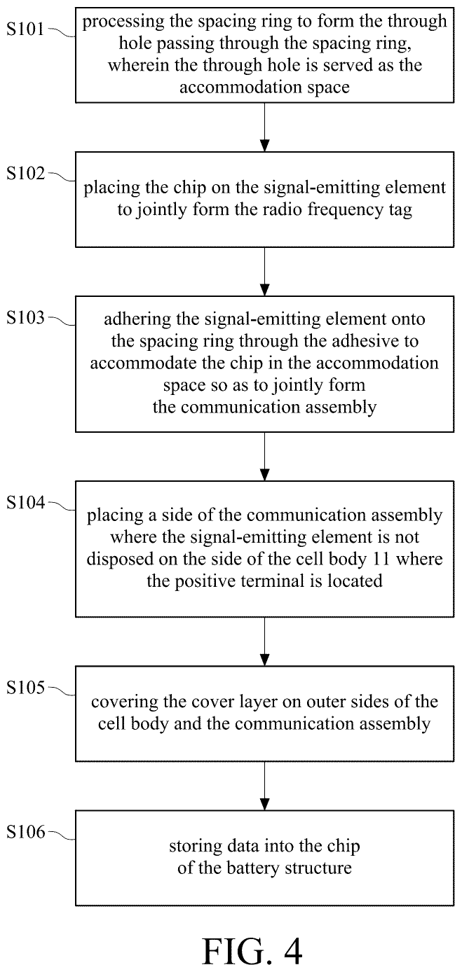

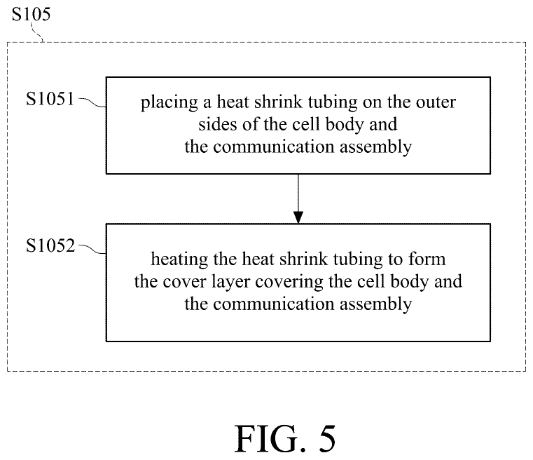

In the following, a manufacturing method of the battery structure 10 is illustrated. Please refer to FIG. 4 to FIG. 5 with the reference to FIG. 1 to FIG. 3, where FIG. 4 to FIG. 5 are flow charts showing a manufacturing method of the battery structure in FIG. 1.

As shown in FIG. 4, a manufacturing method of the battery structure 10 may include steps S101 to S106. The step S101 includes: processing the spacing ring 121 to form the through hole passing through the spacing ring 121, wherein the through hole is served as the accommodation space 1211. The step S102 includes: placing the chip 1222 on the signal-emitting element 1221 to jointly form the radio frequency tag 122. The step S103 includes: adhering the signal-emitting element 1221 onto the spacing ring 121 through the adhesive 123 to accommodate the chip 1222 in the accommodation space 1211 so as to jointly form the communication assembly 12. The step S104 includes: placing a side of the communication assembly 12 where the signal-emitting element 1221 is not disposed on the side of the cell body 11 where the positive terminal 111 is located. The step S105 includes: covering the cover layer 13 on outer sides of the cell body 11 and the communication assembly 12, wherein the cover layer 13 exposes the positive terminal 111, at least part of the negative terminal 112 and at least part of the signal-emitting element 1221. The step S106 includes: storing data into the chip 1222 of the battery structure 10.

As shown in FIG. 5, the step S105 may include steps S1051 to S1052. The step S1051 includes: placing a heat shrink tubing (not shown in the drawings) on the outer sides of the cell body 11 and the communication assembly 12. The step S1052 includes: heating the heat shrink tubing to form the cover layer 13 covering the cell body 11 and the communication assembly 12.

According to the manufacturing method discussed above, the chip 1222 can be prevented from being affected during the manufacturing, such that the yield rate of the communication assembly 12 can be improved.

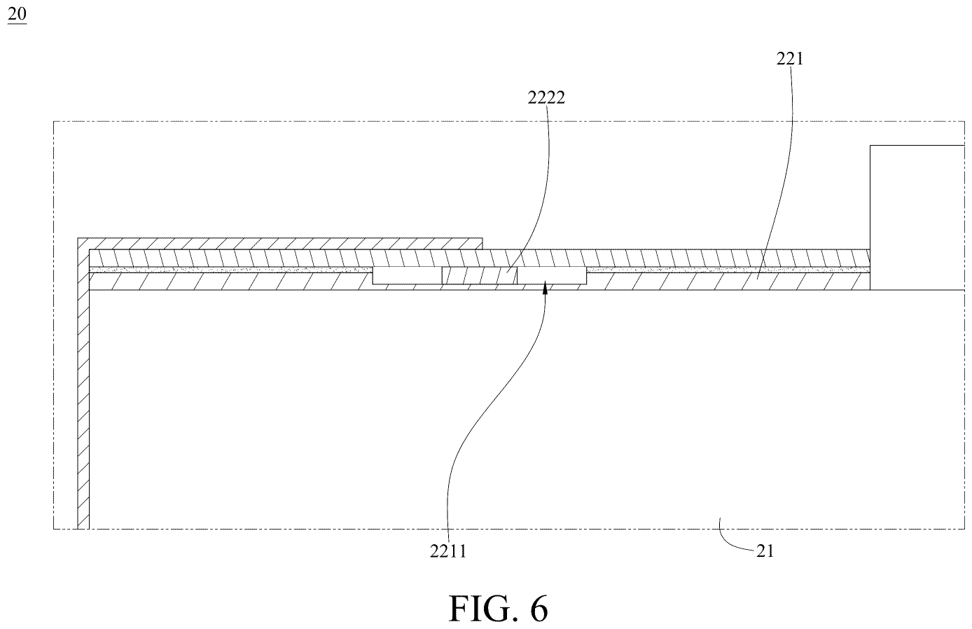

In the abovementioned embodiment, the accommodation space 1211 may be the through hole passing through the spacing ring 121, but the present disclosure is not limited thereto. Please refer to FIG. 6, which is a partial and enlarged view of a battery structure according to another embodiment of the present disclosure.

A battery structure 20 provided in this embodiment is similar in structure with the battery structure 10 of the previous embodiment, and thus only difference, as well as necessary description, will be illustrated.

As shown in FIG. 6, the accommodation space 2211 of the spacing ring 221 may be a blind hole not passing through the spacing ring 221. Therefore, any possible short circuit between the chip 2222 and the cell body 21 can be further prevented.

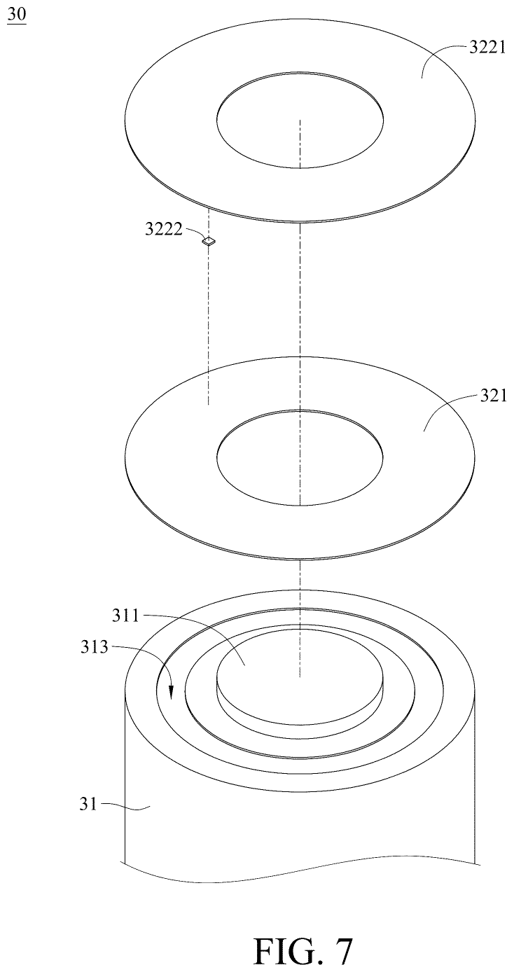

In the abovementioned embodiment, the accommodation spaces 1211 and 2211 may be respectively the through hole passing through the spacing ring 121 and the blind hole not passing through the spacing ring 221, but the present disclosure is not limited thereto. Please refer to FIG. 7, which is an exploded view of several components of a battery structure according to further another embodiment of the present disclosure.

A battery structure 30 provided in this embodiment is similar in structure with the battery structure 10 of the first embodiment, and thus only difference, as well as necessary description, will be illustrated.

As shown in FIG. 7, the cell body 31 has an accommodation space 313 on the side thereof where the positive terminal 311 is located, and the accommodation space 313 is a recess surrounding the positive terminal 311. The spacing ring 321 has no opening. The chip 3222 is directly clamped between the spacing ring 321 and the signal-emitting element 3221. The chip 3222 may be accommodated in the accommodation space 313 with the spacing ring 321 being located therebetween so as to prevent any protrusion of the signal-emitting element 3221 in appearance at the place where the chip 3222 is correspondingly arranged.

The embodiments are chosen and described in order to best explain the principles of the present disclosure and its practical applications, to thereby enable others skilled in the art best utilize the present disclosure and various embodiments with various modifications as are suited to the particular use being contemplated. It is intended that the scope of the present disclosure is defined by the following claims and their equivalents.

What is claimed is:

1. A battery structure comprising:
a cell body having a positive terminal and a negative terminal that are opposite to each other;
a communication assembly comprising:
a spacing ring disposed on a side of the cell body where the positive terminal is located; and
a radio frequency tag comprising:
a signal-emitting element in a ring shape and disposed on a side of the spacing ring away from the cell body; and
at least one chip disposed on a side of the signal-emitting element close to the spacing ring, wherein the spacing ring has at least one accommodation space or the cell body has at least one accommodation space on the side thereof where the positive terminal is located, and the at least one chip is located in the at least one accommodation space; and
a cover layer covering the cell body and the communication assembly and exposing the positive terminal, at least part of the negative terminal, and at least part of the signal-emitting element.

2. The battery structure according to claim 1, wherein the spacing ring and the signal-emitting element surround the positive terminal.

3. The battery structure according to claim 1, wherein the spacing ring has the at least one accommodation space, and the at least one accommodation space is a through hole passing through the spacing ring or a blind hole not passing through the spacing ring.

4. The battery structure according to claim 1, wherein the cell body has the at least one accommodation space on the side thereof where the positive terminal is located, and the at least one accommodation space is a recess surrounding the positive terminal.

5. The battery structure according to claim 1, wherein the at least one chip and the cell body are spaced apart from each other.

6. The battery structure according to claim 1, wherein the communication assembly further comprises an adhesive, and the signal-emitting element is attached to the spacing ring through the adhesive.

7. The battery structure according to claim 1, wherein the spacing ring is made of ferrite or electromagnetic wave absorbing material.

8. A communication assembly configured to be disposed on a cell body, the communication assembly comprising:
a spacing ring; and
a radio frequency tag comprising:
a signal-emitting element in a ring shape and disposed on a side of the spacing ring; and
at least one chip disposed on a side of the signal-emitting element close to the spacing ring;
wherein a side of the communication assembly where the signal-emitting element is not disposed is configured to be disposed on a side of the cell body where a positive terminal is located.

9. The communication assembly according to claim 8, wherein the at least one chip is clamped between the spacing ring and the signal-emitting element.

10. The communication assembly according to claim 8, wherein the spacing ring has at least one accommodation space, and the at least one chip is located in the at least one accommodation space.

11. The communication assembly according to claim 10, wherein the at least one accommodation space is a through hole passing through the spacing ring or a blind hole not passing through the spacing ring.

12. The communication assembly according to claim 8, further comprising an adhesive, wherein the signal-emitting element is attached to the spacing ring through the adhesive.

13. The communication assembly according to claim 8, wherein the spacing ring is made of ferrite or electromagnetic wave absorbing material.

14. A manufacturing method of a battery structure comprising:
placing at least one chip on a signal-emitting element to jointly form a radio frequency tag;
attaching the signal-emitting element to a spacing ring to jointly form a communication assembly;
placing a side of the communication assembly where the signal-emitting element is not disposed on a side of a cell body where a positive terminal is located; and
covering a cover layer on outer sides of the cell body and the communication assembly, wherein the cover layer exposes the positive terminal, at least part of a negative terminal of the cell body, and at least part of the signal-emitting element.

15. The manufacturing method according to claim 14, further comprising:
storing data into the at least one chip of the radio frequency tag.

16. The manufacturing method according to claim 14, further comprising:
processing the spacing ring to form at least one accommodation space;
wherein attaching the signal-emitting element to the spacing ring to jointly form the communication assembly comprises:
attaching the signal-emitting element to the spacing ring to placing the at least one chip in the at least one accommodation space so as to jointly form the communication assembly.

17. The manufacturing method according to claim 16, wherein processing the spacing ring to form the at least one accommodation space comprises:
forming a through hole passing through the spacing ring or forming a blind hole not passing through the spacing ring, so that the through hole or the blind hole is served as the at least one accommodation space.

18. The manufacturing method according to claim 14, wherein attaching the signal-emitting element to the spacing ring comprises: adhering the signal-emitting element onto the spacing ring through an adhesive.

19. The manufacturing method according to claim 14, wherein covering the cover layer on the outer sides of the cell body and the communication assembly comprises:
placing a heat shrink tubing on the outer sides of the cell body and the communication assembly; and
heating the heat shrink tubing to form the cover layer covering the cell body and the communication assembly.
